(19) United States
(12) Patent Application Publication
(10) Pub. No.: US 2022/0092751 A1
(43) Pub. Date: Mar. 24, 2022

(54) EFFICIENT HARDWARE GUIDED FILTERING METHOD FOR USE IN MULTI-LABEL PROBLEM

(71) Applicant: Nanjing University of Science and Technology, Nanjing City (CN)

(72) Inventors: Longquan DAI, Nanjing City (CN); Jingru WANG, Nanjing City (CN); Jinhui TANG, Nanjing City (CN)

(21) Appl. No.: 17/422,455

(22) PCT Filed: Jan. 2, 2020
(86) PCT No.: PCT/CN2020/070051

§ 371 Date: Jul. 13, 2021

(30) Foreign Application Priority Data
Jan. 18, 2019 (CN) 201910047862.2

(51) Int. Cl. G06T 5/20; G06F 17/16; G06F 17/12; G06T 5/00

(52) U.S. Cl. CPC G06T 5/20; G06T 5/003; G06F 17/12; G06F 17/16

(57) ABSTRACT

The present invention provides an efficient hardware guided filtering method for use in solving a multi-label problem. The method includes the following steps: inputting an input guidance of a multi-label image; defining an efficient hardware guided filtering (HGF) model; calculating a vector by a customized matrix inversion operation; inputting guidance through a mapping program for adding up result of each channel to form a polynomial guidance, and introducing nonlinearity into the linear model; and obtaining a filtering result in an efficient hardware mode by element-wise calculation and box filtering.

### CROSS-REFERENCES TO RELATED APPLICATIONS

This application is a 371 application of PCT application number PCT/CN2020/070051 filed Jan. 2, 2020 claiming priority from a Chinese patent application number 201910047862.2 filed Jan. 18, 2019, which are hereby incorporated herein by reference in its entirety for all purposes.

### FIELD OF THE INVENTION

The present invention relates to the field of computer vision techniques in a multi-channel guiding the filtered image, particularly an efficient hardware guided filtering method for use in a multi-label problem.

### BACKGROUND OF THE INVENTION

Since 2010, guided filtering (GF) has been used to many problems in computer vision and graphics such as image redirection, color transfer and video defogging. Among them, a multi-label system may be one of the most suitable applications for GF to fully utilize its efficiency and effects, because the heavy calculations in the multi-label system urgently require a fast filtering tool.

Due to linear complexity and edge preservation abilities, GF is considered to be the best choice among all candidate filters in a multi-label system. However, a shortcoming of GF is that the color image guided filtering algorithm is not efficient. It is observed that the running time increases significantly according to the size of the matrix. Specifically, matrix inversion is a time-consuming operation. Therefore, it is inefficient to apply GF to a multi-label system with multi-channel guidance, especially for a large number of channels.

In order to reduce the execution time, the most direct method of GF is to start a group of threads to invert the matrix at the same time. However, this strategy is not efficient on current hardware. This is because: (1) Both CPU and GPU rely on Single Instruction Multiple Data (SIMD) architecture to improve performance; (2) Branch instructions are inevitable for traditional matrix inversion methods such as LU algorithm; (3) The SIMD architecture cannot run branch instructions at the fastest speed, because these instructions need to decompose each vector into elements and process them sequentially on the architecture. In order to avoid branch instructions, the matrix can be inverted according to an analytical solution of the matrix inversion. GF uses the fastest OpenCV to implement this strategy to invert the 3×3 matrix, and successfully reduces the running time of inverting 106 matrices to less than 100 ms. However, the implementation complexity of the analysis solution increases as the size of the matrix increases. When the size of the matrix becomes larger, this method can no longer be implemented manually.

### SUMMARY OF THE INVENTION

An objective of the present invention is to provide an efficient hardware guided filtering method for use in a multi-label problem, where the method includes:

Step 1, inputting the input guidance of a multi-label image;

Step 2, defining an efficient hardware guided filtering (HGF) model;

Step 3, calculating a vector \vec{wₚ} by a customized matrix inversion operation;

Step 4, inputting guidance through a mapping program for adding up result of each channel to form a polynomial guidance, and introducing nonlinearity into the linear model;

Step 5, obtaining a filtering result in an efficient hardware mode by element-wise calculation and box filtering.

The invention adopts element-wise arithmetic calculation and box filtering, having the following advantages: (1) Introducing nonlinearity to GF by inputting synthetic polynomial multi-channel guidance to overcome the shortcomings of GF linear model; (2) Linear models are usually not suitable for the input data due to their simplicity, so they tend to produce excessively smooth results; (3) Through the hardware efficient matrix inversion algorithm, the additional running time accompanying the nonlinear model can be reduced to an acceptable level.

The present invention will be further described below in conjunction with the accompanying drawings of the specification.

### BRIEF DESCRIPTION OF THE DRAWINGS

FIG. 1 is a flowchart of the present invention.

FIG. 2 is a flowchart of HGF using input filtering from a multi-label system.

### DETAILED DESCRIPTION

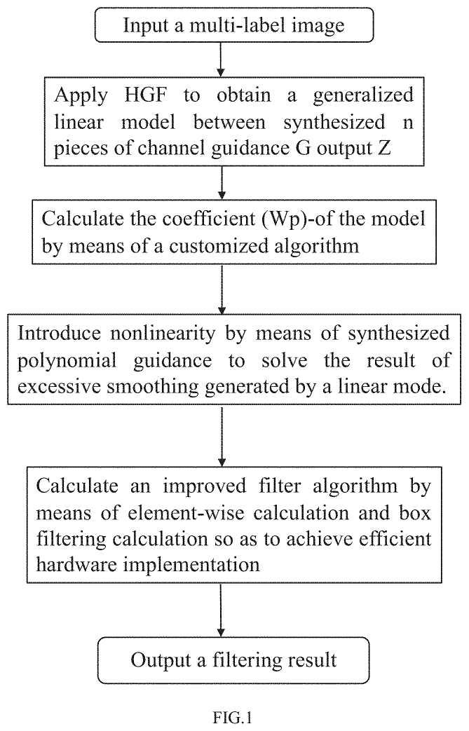

With reference to FIG. 1, an efficient hardware guided filtering method for use in a multi-label problem includes a total of four processes: (1) Definition of HGF; (2) Calculation of vector \vec{wₚ}; (3) Synthetic polynomial guidance; (4) Efficient hardware implementation.

(1) Defining HGF Includes the Following Steps:

Step 1. multi-point estimation: to calculate the estimation of a group of points in local support. Specifically, HGF estimates the coefficient \vec{wₚ} of the filter model (1) by minimizing linear ridge regression (2), where Y represents the input image.

$$\begin{matrix}Z ( q ) = {\sum }_{i = 1}^{n} \vec{{w}_{p}} ( i ) {G}_{i} ( q ) + \vec{{w}_{p}} ( 0 ) , ∀ q ∈ {Ω}_{p} & ( 1 ) \\ {min}_{\vec{{w}_{p}}} λ {‖ \vec{{w}_{p}} ‖}_{2}^{2} + {\sum }_{q ∈ {Ω}_{p}} {( Y ( q ) - {\sum }_{i = 1}^{n} \vec{{w}_{p}} ( i ) {G}_{i} ( q ) - \vec{{w}_{p}} ( 0 ) )}^{2} & ( 2 )\end{matrix}$$

Step 2. Aggregation: Fusion of each point available for multi-point estimates.

Equation (2) is used to optimize equation (1) to minimize \vec{wₚ} input HGF, getting a set of values Zₚ′(q)=Σᵢ₌₁ⁿ \tilde{w}_{i,p} Gᵢ(q)+\vec{w}_{0,p}, q∈Ωₚ for a given window Ωₚ; HGF aggregates these values together, and regards their average value

$$\frac{1}{\vert {Ω}_{q} \vert} {\sum }_{p ∈ {Ω}_{q}} {Z}_{p}^{′} ( q )$$

as the final filtering result Z(q).

$$\begin{matrix}Z ( q ) = \frac{1}{\vert {Ω}_{q} \vert} {\sum }_{p ∈ {Ω}_{q}} {\sum }_{i = 1}^{n} \vec{{w}_{p}} ( i ) {G}_{i} ( q ) + \vec{{w}_{p}} ( 0 ) \\ = {\sum }_{i = 1}^{n} {\vec{w}}_{q}^{a} ( i ) {G}_{i} ( q ) + {\vec{w}}_{q}^{a} ( 0 )\end{matrix} \qquad ( 3 )$$

(2) Calculating the Vector \vec{wₚ} Includes the Following Steps:

Step 3. To calculate the vector \vec{wₚ} according to equation (4) including the matrix inversion operation (λE+X_{P}^{T}Xₚ)⁻¹. E represents the identity matrix, the matrix Xₚ=[\vec{c}_{0,p}, . . . , \vec{c}_{n,p}] of input image pixel p. For the i^{th} vector \vec{c}_{i,p} of P, \vec{c}_{i,p}=[Gᵢ(q₁), . . . , Gᵢ(q_{|Ω}_{ₚ}_{|})]^{T} (0≤i≤n+1) is added to the record value Gᵢ(qₖ) of the k^{th} output pixel, wherein qₖ∈Ωₚ, Ωₚ represents the neighboring region centered on the pixel P; and |Ωₚ| represents the total number of pixels in Ωₚ, and the image is Gᵢ.

\vec{wₚ}=(λE+X_{P}^{T}Xₚ)⁻¹Xₚ^{T}\vec{c}_{n,p} (4)

Step 4. Replacing λE+X_{P}^{T}Xₚ by λE+Σᵢ₌₀ⁿ \vec{c}_{i,p} \vec{c}_{i,p}^{T}, equation (4) is re-expressed as equation (5).

\vec{wₚ}=X_{P}^{T}(λE+X_{P}^{T}Xₚ)⁻¹\vec{c}_{n+1,p}=[\vec{c}_{0,p}^{T}, . . . ,\vec{c}_{n,p}^{T}]^{T}(λE+Σᵢ₌₀ⁿ\vec{c}_{i,p}\vec{c}_{i,p}^{T})⁻¹\vec{c}_{n+1,p} (5)

Step 5, if λE+Σᵢ₌₀ⁿ \vec{c}_{i,p} \vec{c}_{i,p}^{T} is invertible in step 4, then equation (6) is valid. Where α_{ij,p}=α_{ij,p}ⁿ, and can be calculated through equation (7) iterative calculation, k is from 1 to n, wherein

$$\begin{matrix}{α}_{00}^{0} = - {( λ + {G}_{00 , p} )}^{- 1} \\ {G}_{i j , p} = {\vec{c}}_{i , p}^{T} {\vec{c}}_{j , p} \\ {F}_{i j , p}^{k} = {\sum }_{m , n = 0}^{k - 1} {α}_{i m , p}^{k - 1} {α}_{n j , p}^{k - 1} {G}_{m k , p} {G}_{k n , p} \\ {γ}_{p}^{k} = - {( 1 + {λ}^{- 1} {G}_{k k , p} + {\sum }_{m , n = 0}^{k - 1} {α}_{m n , p}^{k - 1} {G}_{k m , p} {G}_{n k , p} )}^{- 1} \\ {( λ E + {\sum }_{i = 0}^{n} {\vec{c}}_{i , p} {\vec{c}}_{i , p}^{T} )}^{- 1} = {λ}^{- 1} E + {\sum }_{i , j = 0}^{n} {α}_{i j , p} {\vec{c}}_{i , p} {\vec{c}}_{j , p}^{T} & ( 6 ) \\ {α}_{i j , p}^{k} = \{ \begin{matrix}{γ}_{p}^{k} {F}_{i j , p}^{k} + {α}_{ij , p}^{k - 1} & i < k , j < k \\ {λ}^{- 1} {γ}_{p}^{k} ( {\sum }_{n = 0}^{k - 1} {α}_{i n , p}^{k - 1} {G}_{n j , p} ) & i < k , j = k \\ {λ}^{- 1} {γ}_{p}^{k} ( {\sum }_{m = 0}^{k - 1} {α}_{m j , p}^{k - 1} {G}_{i m , p} ) & i = k , j < k \\ {λ}^{- 2} {γ}_{p}^{k} & i < k , j = k\end{matrix} & ( 7 )\end{matrix}$$

Step 6, to put the equation (6) into equation (5): the k^{th} element \vec{wₚ}(k) of \vec{wₚ} converts into a linear combination G_{ij,p} as in equation (8).

$$\vec{{w}_{p}} ( k ) = {{\vec{c}}_{k , p}^{T} ( λE + {\sum }_{i = 0}^{n} {\vec{c}}_{i , p} {\vec{c}}_{i , p}^{T} )}^{- 1} {\vec{c}}_{n + 1 , p} = {\vec{c}}_{k , p}^{T} ( {λ}^{- 1} E + {\sum }_{i , j = 0}^{n} {α}_{i j , p} {\vec{c}}_{i , p} {\vec{c}}_{j , p}^{T} ) {\vec{c}}_{n + 1 , p} = {λ}^{- 1} {I}_{k n + 1 , p} + {\sum }_{i , j = 0}^{n} {α}_{i j , p} {I}_{k i , p} {I}_{j n + 1 , p} \qquad ( 8 )$$

Step 7, there is a vector inner product result of point p: G_{ij,p}=\vec{c}_{i,p}^{T} \vec{c}_{j,p}=Σₖ₌₁^{|Ω}^{ₚ}^{|}Gᵢ(qₖ)Gⱼ(qₖ)=Σ_{q∈Ω}_{ₚ} Gᵢ(q)Gⱼ(q), and the box filtering result Gᵢⱼ(p)=Σ_{q∈Ω}_{ₚ} GᵢGⱼ(q)=Σ_{q∈Ω}_{ₚ} Gᵢ(q)Gⱼ(q), so if the neighboring region Ωₚ of p is a box window, since there is G_{ij,p}=Gᵢⱼ(p), the box filter is applied to the element to generate the image to form Gᵢⱼ, \vec{wₚ}(k) is calculated according to the linear combination of Gᵢⱼ to form \vec{wₚ}. The above steps 4), 5), 6), and 7) only consist of arithmetic calculations and box filtering, which completely eliminates matrix inversion operations in the calculation process.

(3) The Synthetic Polynomial Guidance Includes the Following Steps:

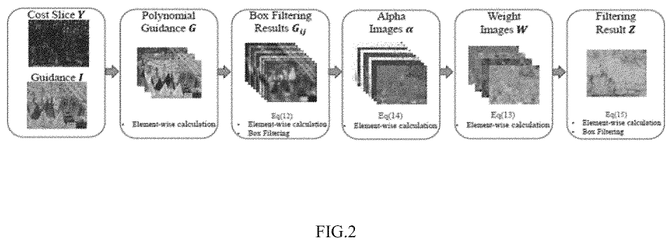

With reference to FIG. 2, in step 8, equation (9) shows a polynomial model guidance I with gray input, where d is the degree of the polynomial function. Assuming Gᵢ=Iⁱ, the equivalence between the linear model (1) and the polynomial model (9) can be found, when the input guidance is multi-channel, the mapping program G_{(i-1)d+j}=Iᵢ^{j} is applied directly to each channel independently, where Iᵢ represents the i^{th} channel of the multi-channel guide I, and n is the number of channels. After that, the results of each channel of the input multi-channel guide I are superimposed to form a polynomial guidance. Mathematically, the linear model (1) in this case is equivalent to the nonlinear polynomial model (10). Therefore, the nonlinearity is successfully assigned to the generalized linear model (1) of HGF.

Z(q)=Σᵢ₌₁^{d}=\vec{wₚ}(i)Iⁱ(q)+\vec{wₚ}(0),∀q∈Ωₚ (9)

Z(q)=Σᵢ₌₁ⁿΣⱼ₌₁^{d}\vec{wₚ}((i−1)d+j)Iᵢ^{j}(q)+\vec{wₚ}(0) (10)

(4) Efficient Hardware Implementation Includes the Following Steps:

Step 9, equation (8) reveals the effective hardware method for calculating \vec{wₚ}, guaranteeing that the k^{th} element \vec{wₚ}(k) of \vec{wₚ} is a linear combination of the box filtering result Gᵢⱼ(p). Specifically, [symbol] (X) represents the box filtering result of image X, Wᵢ and αᵢⱼ record the values \vec{wₚ}(k) and α_{ij,p} of any p in the image region (Wᵢ(p)=\vec{wₚ}(i), αᵢⱼ(p)=α_{ij,p}).

Step 10, extending equation (8) to the following box filtering result Gᵢⱼ (11) and element-wise arithmetic calculation (12), G₀ represents all-ones matrix, Gᵢ(1≤i≤n) represents the i^{th} channel of G guided by the synthetic polynomial n channel, Gₙ₊₁ is another representation method of the input image Y.

Gᵢⱼ= [symbol] (GᵢGⱼ) (11)

Wᵢ=λ⁻¹Gₖₙ₊₁+Σ_{i,j=0}ⁿαᵢⱼGₖᵢGⱼₙ₊₁ (12)

Updating the formula α_{ij,p}^{k} can also be modified to the element-wise arithmetic calculation of matrix (13), where α₀₀⁰=−(λ+G_{00,p})⁻¹, F^{k}=Σ_{m,n=0}^{k-1} αᵢₘ^{k-1} αₙⱼ^{k-1} Gₘₖ Gₖₙ, and γ^{k}=−(1+λ⁻¹Gₖₖ+Σ_{m,n=0}^{k-1} αₘₙ^{k-1} Gₖₘ Gₙₖ)⁻¹.

$${α}_{ij}^{k} = \{ \begin{matrix}{F}_{p}^{k} + {α}_{ij}^{k - 1} & i < k , j < k \\ {λ}^{- 1} {γ}^{k} ( {\sum }_{n = 0}^{k - 1} {α}_{i n}^{k - 1} {G}_{nk} ) & i < k , j = k \\ {λ}^{- 1} {γ}^{k} ( {\sum }_{m = 0}^{k - 1} {α}_{mj}^{k - 1} {G}_{k m} ) & i = k , j < k \\ {λ}^{- 2} {γ}^{k} & i = j = k\end{matrix} \qquad ( 13 )$$

Step 11, HGF calculates the filtering result Z according to the average value of the coefficient \vec{wₚ}, defining the average operator [symbol] (X)= [symbol] (X)/ [symbol] (G₀), expressing the element-wise arithmetic calculation form of equation (3) as equation (14):

Z=Σᵢ₌₁ⁿ [symbol] (Wᵢ)Gᵢ+ [symbol] (W₀) (14)

Step 12, observing the equation (11), (12), (13), (14), all equations involve only two calculation types: one is the element-wise arithmetic calculation of the matrix, and the other is the box filtering of the image, element-wise arithmetic calculation is a typical data parallel task. It applies element functions to the actual set of input data. The arithmetic calculation can be directly assigned to the core of the CPU or the threads of the GPU for parallel calculation. Many software or libraries support element-wise arithmetic calculations, such as Matlab, ViennaCL and Arrayfire.

Step 13, the value of the smoothed image produced by the box filtering is equal to the sum of its neighboring pixels in the input image. There is no need to manually implement box filtering, Intel's two libraries, the NPP of OpenCV and Nvidia are already available.

What is claimed is:

1. An efficient hardware guided filtering method for use in a multi-label problem comprising:
step 1: inputting the input guidance of a multi-label image;
step 2: defining an efficient hardware guided filtering (HGF) model;
step 3: calculating a vector \vec{wₚ} by means of a customized matrix inversion operation;
step 4: inputting guidance through a mapping program for adding up the results of each channel to form a polynomial guidance, and introducing nonlinearity into the linear model; and
step 5: obtaining a filtering result in an efficient hardware mode by means of element-wise calculation and box filtering.

2. The method according to claim 1, wherein the step 2 comprises the following steps:
step 201: defining the HGF by:
Z(q)=Σᵢ₌₁ⁿ\vec{wₚ}(i)Gᵢ(q)+\vec{wₚ}(0),∀q∈Ωₚ (1)
wherein \vec{wₚ}(i) is i^{th} coefficient; \vec{wₚ}(0) is an initial coefficient; Gᵢ(q) is a recorded value of a pixel q;
step 202: minimizing linear ridge regression (2) to estimate equation (1), wherein coefficient \vec{wₚ} of HGF is obtained by:
$${min}_{\vec{{W}_{p}}} λ {‖ \vec{{w}_{p}} ‖}_{2}^{2} + {\sum }_{q ∈ {Ω}_{p}} {( Y ( q ) - {\sum }_{i = 1}^{n} \vec{{w}_{p}} ( i ) {G}_{i} ( q ) - \vec{{w}_{p}} ( 0 ) )}^{2} \qquad ( 2 )$$
wherein Y(q) is an input image; λ is a regularization parameter; and Ωₚ is a neighboring region centered on a pixel P;
step 203: obtaining a set of value Z′ₚ(q) of Ωₚ, adding filtering results of the two pixels together, wherein an average value
$$\frac{1}{\vert {Ω}_{q} \vert} {\sum }_{p ∈ {Ω}_{q}} {Z}_{p}^{′} ( q )$$
is regarded as a final filtering result Z(q), wherein
$${Z}_{p}^{′} ( q ) = {\sum }_{i = 1}^{n} {\vec{w}}_{i , p} {G}_{i} ( q ) + {\vec{w}}_{0 , p} , q ∈ {Ω}_{p}$$
$$\begin{matrix}Z ( q ) = \frac{1}{\vert {Ω}_{q} \vert} {\sum }_{p ∈ {Ω}_{q}} {\sum }_{i = 1}^{n} \vec{{w}_{p}} ( i ) {G}_{i} ( q ) + \vec{{w}_{p}} ( 0 ) \\ = {\sum }_{i = 1}^{n} {\vec{w}}_{q}^{a} ( i ) {G}_{i} ( q ) + {\vec{w}}_{q}^{a} ( 0 )\end{matrix} \qquad ( 3 )$$
wherein \vec{w}_{i,p} is i^{th} coefficient of pixel p, \vec{w}_{0,p} is an initial coefficient of pixel p, and \vec{w}_{q}^{a} is a mean value of \vec{w}ₚ in Ω_{q}.

3. The method according to claim 1, wherein the step 3 comprises the following steps:
step 301: calculating the vector \vec{wₚ} according to the following equation (4) including the customized matrix inversion operation (λE+X_{P}^{T}Xₚ)⁻¹:
\vec{wₚ}=(λE+X_{P}^{T}Xₚ)⁻¹Xₚ^{T}\vec{c}_{n,p} (4)
wherein E is an identity matrix; Xₚ=[\vec{c}_{0,p}, . . . , \vec{c}_{n,p}] is a matrix of input image pixel p, and \vec{c}_{n,p} is the n^{th} vector of pixel p, and
wherein with respect to i^{th} vector \vec{c}_{i,p} of \vec{c}_{i,p}=[Gᵢ(q₁), . . . , Gᵢ(q_{|Ω}_{ₚ}_{|})]^{T} (0≤i≤n+1) is added to a recorded value Gᵢ(qₖ) of the k^{th} output pixel q, wherein qₖ∈Ωₚ, Ωₚ represents a neighboring region centered on the pixel P; and |Ωₚ| represents the total number of pixels in Ωₚ;
step 302: replacing λE+X_{P}^{T}Xₚ by λE+Σᵢ₌₀ⁿ \vec{c}_{i,p} \vec{c}_{i,p}^{T} to obtain equation (5), wherein if the equation is invertible then the equation (6) is valid:
$$\begin{matrix}\vec{{w}_{p}} = {{X}_{P}^{T} ( λ E + {X}_{P}^{T} {X}_{p} )}^{- 1} {\vec{c}}_{n + 1 , p} = {[ {\vec{c}}_{0 , p}^{T} , … , {\vec{c}}_{n , p}^{T} ]}^{T} {( λ E + {\sum }_{i = 0}^{n} {\vec{c}}_{i , p} {\vec{c}}_{i , p}^{T} )}^{- 1} {\vec{c}}_{n + 1 , p} & ( 5 ) \\ {( λ E + {\sum }_{i = 0}^{n} {\vec{c}}_{i , p} {\vec{c}}_{i , p}^{T} )}^{- 1} = {λ}^{- 1} E + {\sum }_{i , j = 0}^{n} {α}_{i j , p} {\vec{c}}_{i , p} {\vec{c}}_{j , p}^{T} & ( 6 ) \\ {α}_{i j , p}^{k} = \{ \begin{matrix}{γ}_{p}^{k} {F}_{i j , p}^{k} + {α}_{ij , p}^{k - 1} & i < k , j < k \\ {λ}^{- 1} {γ}_{p}^{k} ( {\sum }_{n = 0}^{k - 1} {α}_{i n , p}^{k - 1} {G}_{n j , p} ) & i < k , j = k \\ {λ}^{- 1} {γ}_{p}^{k} ( {\sum }_{m = 0}^{k - 1} {α}_{m j , p}^{k - 1} {G}_{i m , p} ) & i = k , j < k \\ {λ}^{- 2} {γ}_{p}^{k} & i < k , j = k\end{matrix} & ( 7 ) \\ {F}_{ij , p}^{k} = {\sum }_{m , n = 0}^{k - 1} {α}_{i m , p}^{k - 1} {α}_{n j , p}^{k - 1} {G}_{m k , p} {G}_{k n , p} & \\ {γ}_{p}^{k} = - {( 1 + {λ}^{- 1} {G}_{k k , p} + {\sum }_{m , n = 0}^{k - 1} {α}_{m n , p}^{k - 1} {G}_{k m , p} {G}_{n k , p} )}^{- 1} & \end{matrix}$$
wherein, k, i, j, m, and n represent superscripts and subscripts of a corresponding matrix,
step 303: putting the equation (6) into the equation (5), and converting the k^{th} element \vec{wₚ}(k) of \vec{wₚ} into a linear combination:
$$\begin{matrix}\vec{{w}_{p}} ( k ) = {{\vec{c}}_{k , p}^{T} ( λ E + {\sum }_{i = 0}^{n} {\vec{c}}_{i , p} {\vec{c}}_{i , p}^{T} )}^{- 1} {\vec{c}}_{n + 1 , p} \\ = {\vec{c}}_{k , p}^{T} ( {λ}^{- 1} E + {\sum }_{i , j = 0}^{n} {α}_{i j , p} {\vec{c}}_{i , p} {\vec{c}}_{j , p}^{T} ) {\vec{c}}_{n + 1 , p} \\ = {λ}^{- 1} {I}_{k n + 1 , p} + {Σ}_{i , j = 0}^{n} {α}_{i j , p} {I}_{k i , p} {I}_{j n + 1 , p}\end{matrix} \qquad ( 8 )$$
step 304: obtaining vector inner product result G_{ij,p} and box filtering result Gᵢⱼ(p) of point p:
G_{ij,p}=\vec{c}_{i,p}^{T}\vec{c}_{j,p}=Σₖ₌₁^{|Ω}^{ₚ}^{|}Gᵢ(qₖ)Gⱼ(qₖ)=Σ_{q∈Ω}_{ₚ}Gᵢ(q)Gⱼ(q)
Gᵢⱼ(p)=Σ_{q∈Ω}_{ₚ}Gᵢ(q)Gⱼ(q)
step 305: if the neighboring region Ωₚ of p is a box window, then G_{ij,p}=Gᵢⱼ(p), applying the box filter to an element to generate image to obtain Gᵢⱼ, and calculating \vec{wₚ}(k) according to a linear combination of Gᵢⱼ to form \vec{wₚ}.

4. The method according to claim 1, wherein the step 4 comprises:
when the input guidance is multi-channel, the mapping program G_{(i-1)d+j}=Iᵢ^{j} is applied directly to each channel independently, and results of each channel of the input multi-channel guide I are superimposed to form a polynomial guidance, nonlinearity is assigned to a generalized linear model (1) of the HGF to obtain a nonlinear polynomial model (10):
Z(q)=Σᵢ₌₁ⁿΣⱼ₌₁^{d}\vec{wₚ}((i−1)d+j)Iᵢ^{j}(q)+\vec{wₚ}(0) (10)
wherein d is a degree of the polynomial function; Iᵢ represents the i^{th} channel of the multi-channel guide I, and n is the number of channels

5. The method according to claim 1, wherein the step 5 comprises the following steps:
step 501: representing a box filtering result of image X as [symbol] (X), Wᵢ and αᵢⱼ recording values of \vec{wₚ}(k) and α_{ij,p} at any p point in the image region;
step 502: extending equation for calculating \vec{wₚ}(k) to those which only use the box filtering result Gᵢⱼ (11) and element-wise arithmetic calculation (12)
$$\begin{matrix}{G}_{i j} = ℬ ( {G}_{i} {G}_{j} ) & ( 11 ) \\ {W}_{i} = {λ}^{- 1} {G}_{k ( n + 1 )} + {\sum }_{i , j = 0}^{n} {α}_{i j} {G}_{k i} {G}_{j ( n + 1 )} & ( 12 ) \\ {α}_{ij}^{k} = \{ \begin{matrix}{F}_{p}^{k} + {α}_{ij}^{k - 1} & i < k , j < k \\ {λ}^{- 1} {γ}^{k} ( {\sum }_{n = 0}^{k - 1} {α}_{i n}^{k - 1} {G}_{nk} ) & i < k , j = k \\ {λ}^{- 1} {γ}^{k} ( {\sum }_{n = 0}^{k - 1} {α}_{mj}^{k - 1} {G}_{k m} ) & i = k , j < k \\ {λ}^{- 2} {γ}^{k} & i = j = k\end{matrix} & ( 13 )\end{matrix}$$
wherein, G₀ represents all-ones matrix; Gᵢ(1≤i≤n) represents the i^{th} channel of G guided by the synthetic polynomial n channel; Gₙ₊₁ represents an input image Y; λ is a regularization parameter; i, j, k, (n+1) represent superscripts and subscripts of a corresponding matrix
a₀₀⁰=−(λ+G_{00,p})⁻¹
F^{k}=Σ_{m,n=0}^{k-1}αᵢₘ^{k-1}αₙⱼ^{k-1}GₘₖGₖₙ
γ^{k}=−(1+λ⁻¹Gₖₖ+Σ_{m,n=0}^{k-1}αₘₙ^{k-1}GₖₘGₙₖ)⁻¹;
step 503: HGF calculating the filtering result Z according to an average value of coefficient \vec{wₚ}, defining an average operator [symbol] (X)= [symbol] (X)/ [symbol] (G₀), the element-wise arithmetic calculation form of the filtering result calculation equation of equation (3) is expressed as equation (14):
Z=Σᵢ₌₁ⁿ [symbol] (Wᵢ)Gᵢ+ [symbol] (W₀) (14);
step 504, obtaining the filtering result after HGF fast filtering.
